(19) United States
(12) Patent Application Publication
(10) Pub. No.: US 2025/0235845 A1
(43) Pub. Date: Jul. 24, 2025

(54) Method And Apparatus To Activate Molecules In A Fluid

(71) Applicant: Soave Enterprises LLC, Detroit, MI (US)

(72) Inventor: James W. RIDGWAY, Manistique, MI (US)

(21) Appl. No.: 18/986,097

(22) Filed: Dec. 18, 2024

Related U.S. Application Data
(60) Provisional application No. 63/614,137, filed on Dec. 22, 2023.

(51) Int. Cl. B01J 19/08; B01F 23/23

(52) U.S. Cl. CPC B01J 19/088; B01F 23/2319; B01J 2219/0849

(57) ABSTRACT

A plasma generated by a plasma generator is used to activate a fluid in a variety of ways to generate a plasma activated liquid or gas. The plasma generator may be controlled to optimize, such as maximize, a radical concentration in the plasma activated liquid or gas. The plasma activated fluid may be applied to various items, surfaces, and/or added to fluid volumes to affect chemical specifies and organism therein.

### CROSS-REFERENCE TO RELATED APPLICATIONS

This application is a utility of U.S. Patent Application No. 63/614,137 filed Dec. 22, 2023. The entire disclosure of the above application is incorporated herein by reference.

### FIELD

The subject disclosure relates to a system for generating selected chemical species and/or activating molecules in a liquid.

### BACKGROUND

This section provides background information related to the present disclosure which is not necessarily prior art.

A fluid volume may be treated for various purposes. The purposes may include destruction of selected chemical or biological species. The purposes may include cleaning or sterilization of the water source. The treated fluid may be then used for general clean water purposes, such as drinking, irrigation, discharge, etc.

In various embodiments, the treated liquid may be treated with a gas that has passed through a selected mechanism. For example, a corona may be generated through which a gas is passed. For example, a plasma generation system may include that disclosed in U.S. Pat. No. 10,032,593. The plasma generation unit may be used to generate a plasma and a selected fluid may pass near or through a corona in the plasma generation area, such as water or atmospheric air, and be used to affect organic chemicals and/or organisms.

### SUMMARY

This section provides a general summary of the disclosure and is not a comprehensive disclosure of its full scope or all of its features.

The subject disclosure relates to a system for activating molecules in a fluid—both liquid and/or gas, including infusing a selected generated gas into a selected water volume or directly activating a liquid for destruction and/or neutralization of selected compounds and/or organisms, including chemical and/or biological species within the selected liquid volume. A selected gas may be activated in a selected manner. For example, atmospheric air may pass a plasma generation area to generate plasma-activated gas (PAG). The PAG may be a partially or wholly ionized gas composed essentially of photons, ions, and free electrons as well as atoms in their fundamental or excited states possessing a net neutral charge. The PAG may include gas that is generated with a generation system such as that disclosed in U.S. Pat. No. 10,032,593, incorporated herein by reference.

A selected liquid may be activated in a selected manner. For example, water may pass a plasma generation area to generate plasma-activated liquid (PAL). The PAL may be a partially or wholly ionized liquid composed essentially of photons, ions, and free electrons as well as atoms in their fundamental or excited states possessing a net neutral charge. The PAL may include hydrogen peroxide and associated byproducts that are generated by a generation system such as that disclosed in U.S. Pat. No. 10,032,593, incorporated herein by reference.

The PAG, particularly when atmospheric air is used as the source gas, may include various chemical species including hydroxyl ions, oxygen radicals, nitrogen radicals, or other selected chemical species which may or may not include hydrogen peroxide or nitrous oxide. Also, the PAG may rapidly change as it exits the generation system but forms relatively stable but reactive gases like ozone, hydrogen peroxide, singlet oxygen, nitrous oxide, and other reactive gases.

The amount and/or concentration of the reactive fluids may be dependent on the size and number of the coronas within the plasma generator, the dwell time in the plasma generator, the flow rate of the carrier gas, the distance and time between generation and infusion into carrier fluid (water or gas). The various species in the PAG may be mixed with the carrier fluid.

In various embodiments, a plasma activated liquid (PAL) may also be formed directly or indirectly. The PAL may be formed by mixing the PAG with a selected liquid. In various embodiments, selected species may also be formed directly in a liquid. The species may be formed by a corona of a plasma interacting with the liquid. The liquid may be any appropriate liquid, such as ground or surface water, purified water, distilled water, combinations thereof, etc. The PAL may be useful as discussed herein.

The amount of PAG and/or PAL needed for a specific application is dependent on the concentration of the selected active species (e.g., the selected active chemical species) at the application point, the strength and/or concentration of the species of interest (also referred to as target pollutant), species (such as chemical or biological species), and the difficulty of treatment of the target pollutant. In certain applications, a single pass is sufficient to infuse sufficient reactive gas to destroy the species of interest, for example, blue green algae (Cyanobacteria) are no longer viable after contacting sufficient concentration of selected active species. In other applications, the species of interest, like PFAS, are disassociated and reform to other species of PFAS and therefore may require more than one contact with selected active species. With PFAS, the chemical structure may be or is disrupted in a single pass, but the PFAS can recombine to become shorter chained PFAS. If these applications, multiple passes may be required to render the chemical non-toxic and become non-associated carbon and fluoride molecules. In certain embodiments, a higher concentration may also be adequate rather than multiple passes to achieve a selected result.

The plasma-activated gas may be moved from a generation volume (e.g., in a PAG generator) to a secondary volume. For example, a fluid mixing system to efficiently mix the PAG with a non-reactive carrier gas and/or mix (e.g., dissolve) the gas into a liquid. The transfer rate of PAG into the liquid is a function to liquid-to-gas surface area, contact time, pressure at the transfer point, and saturation concentration of the individual gas components. Gas Infusion System may involve an aeration system, an infusion system/injection system, and/or a pressurized emulsion system. These systems are designed to increase the concentration of gas while minimizing the loss of gas through excessive bubbles. These systems may be connected to the PAG generator. The PAG generator may be any appropriate generator of PAG. The fluid mixing system may flow or move the PAG to a secondary volume. In various embodiments the PAG can be infused into a target liquid using aeration, spraying the target liquid through a PAG gas chamber, and/or infusion. In various embodiments, for example, one or more venturi flow tubes may be used to infuse the PAG into a selected volume of water. In various embodiments, a venturi member (e.g., a Venturi pressure injector) may be used to infuse a selected volume of water with the PAG. The mixing system may attempt to saturate, super-saturate, or achieve a selected concentration of the PAG in the selected liquid. The system can increase gas delivery, optimize gas concentration, and minimize gas loss. One skilled in the art, however, will understand that the fluid mixing system, as discussed herein, may be applied to a selected PAG generation system and may be used for various purposes.

Once the PAG is mixed with a liquid (e.g., water), the mixed PAG and liquid (e.g., PAG infused liquid) may be referred to as gas activated liquid (GAL). The GAL, which may be understood as another form of PAL, and behaves in a similar manner to PAL. Both GAL and directly activated PAL may be used for various purposes. The GAL may be used to clean various items, such as surfaces or surface areas. In addition, the GAL may be used to destroy species of interest, such as problematic chemical or biological species and/or further sterilize or clean larger volumes, such as a water supply, a pond, water body or wastewater basins. The GAL may be used to destroy and/or neutralize various chemical species, biological agents, or the like. Further, the GAL may be used to assist in agriculture and/or aquaculture such as to ensure a clean and healthy growing environment, to enhance seed germination and growth, and/or control bacteria, virus, and fungus in irrigation systems. The GAL can be used for lake/river/harbor restoration targeting destruction and/or control of blue green algae (cyanobacteria) and/or red tide (Karenia).

As noted above, the PAL may also be formed by activating species in a liquid volume. For example, a plasma corona may directly activate liquid compounds to form selected active species within the liquid, such as water. When the selected active compounds are formed directly in the liquid, a mixing of gas and liquid may not be necessary. The PAL, therefore, may be formed by activating species in the liquid directly. The PAL, then, may be transferred to a selected location such as a treatment location.

In various embodiments, selected activated species from the PAG, PAL, or GAL may be used for various purposes, such as destroying other species of interest including chemical or biological species. Any or all of the PAG, PAL, or GAL may interact with the species of interest. For example, PAG that is dissolved in a liquid (e.g., GAL) may interact. PAG that is within a bubble (e.g., after being mixed with the liquid GAL) may interact once released and/or when the species of interest enters the bubble. Also, the PAL that is directly activated may interact with the species of interest.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a schematic view of a gas infusion system, according to various embodiments;

FIG. 2 is a detail schematic view of a portion of the gas infusion system of FIG. 1, according to various embodiments;

FIG. 3 is a detail schematic view of a portion of the gas infusion system of FIG. 1, according to various embodiments;

FIG. 4 is a detail schematic view of a portion of the gas infusion system of FIG. 1, according to various embodiments;

FIG. 5 is a schematic view of a gas infusion system and activated gas generation system, according to various embodiments;

FIG. 6A is a schematic view of a plasma generation system such as for generating plasma activated gas, according to various embodiments;

FIG. 6B is a schematic view of a plasma generation system such as for generating plasma activated gas, according to various embodiments;

FIG. 6C is a schematic view of a plasma generation system such as for generating plasma activated gas, according to various embodiments;

FIG. 7 is a schematic view of a plasma generation system such as for generating plasma activated liquid, according to various embodiments; and

FIG. 8A is a schematic view of a plasma generation system such as for generating plasma activated liquid, according to various embodiments;

FIG. 8B is a cross-sectional view taken along line 8B-8B of FIG. 8A, and

FIG. 9 is a schematic view of a plasma activated fluid generation system, according to various embodiments.

Corresponding reference numerals indicate corresponding parts throughout the several views of the drawings.

### DETAILED DESCRIPTION

Example embodiments will now be described more fully with reference to the accompanying drawings.

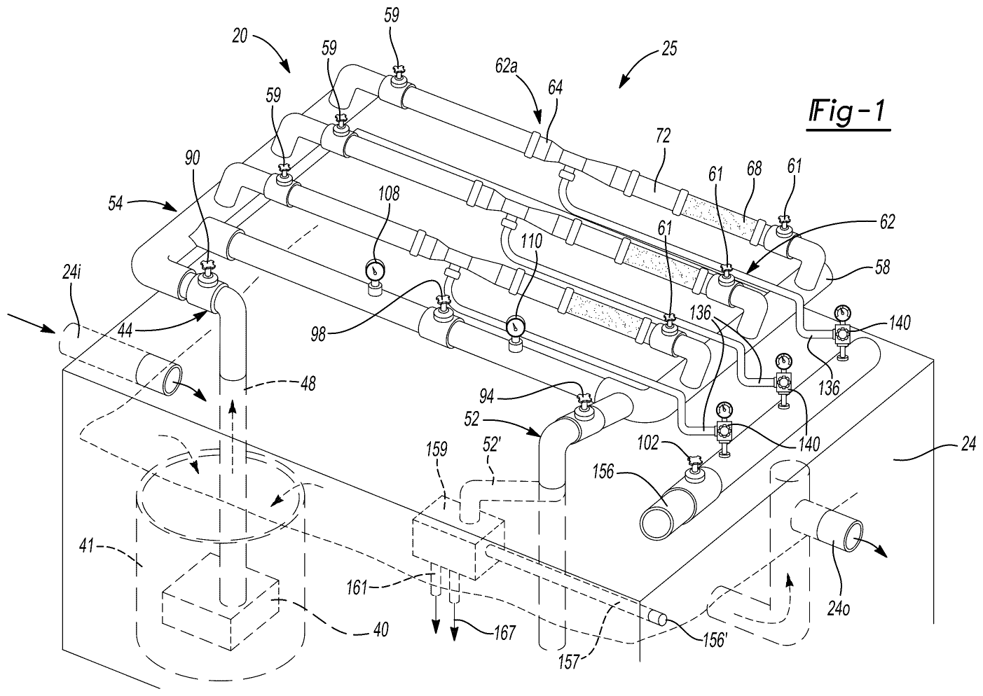

With initial reference to FIG. 1, a gas and fluid mixing system is exemplary illustrated as an infusion system 20. As discussed herein, the mixing system may be the infusion system 20, but it is understood by one skilled in the art that the infusion system may be replaced and/or augmented for dissolving the PAG into the liquid. The infusion system 20 may be used to infuse gas into a selected volume of liquid, such as a volume of liquid included within a tank 24. The tank 24 may hold a selected volume of water, such as an auxiliary or treated volume of water. Once the water in the tank has sufficient dissolved PAG, which may be referred to as gas activated liquid (GAL), the GAL from the tank 24 may then be transferred to a secondary or main volume of liquid, such as water, in either a continuous or batch process. Further, it is understood, that the infusion system 20 may be directly connected to the main volume of water and the recirculating treatment in the intermediate or auxiliary volume, for example as contained in the tank 24, may not be necessary. In various embodiments, however, it may be efficient or compact to treat the auxiliary volume of water, such as in the tank 24, to control and optimize the amount of PAG infused and transport or move the auxiliary treated volume of water to a secondary or main volume of water.

Exemplarily discussed herein is water as a liquid that may be infused with the gas and/or may be treated with gas (e.g., plasma activated gas (PAG)) and/or GAL. It is understood, however, that any appropriate liquid may be treated and/or mixed with the PAG unless specifically noted herein. Further, while the following discussion relates and includes a discussion of infusing a selected gas into a selected volume of water, it is understood that any appropriate fluid, such as a liquid, may be infused with the gas with infusion system 20. Therefore, water is merely exemplary.

In various embodiments, water being infused with the gas may include a selected or first volume of water to allow for treatment of a second volume of water. The final treated volume may include a wastewater treatment tank/pond, an aquaculture system, an irrigation volume of water, a natural body of water such as a lake, river, or stream, or the like. Thus, the volume of water that is treated with the infusion system 20 may be used for any appropriate purposes such as cleaning or sterilization of a surface, cleaning or sterilization of a large volume of water, or assisting in other processes, such as irrigation and aquaculture.

Further, the treatment provided by the infused water, such as the initial or auxiliary treated volume may be used for destruction and/or neutralization of selected species. Species may include the chemical species such as selected one or more Per- and Polyfluorinated Substances (PFAS) including those referred to as perfluorooctane sulfonate (PFOS) and or perfluorooctanoic acid (PFOA). Various other chemical species may also be degraded, in addition to PFAS including short-chain PFAS. Also, various biological organisms may be destroyed or inactivated, such as various bacteria, molds, fungi, or other species including blue green algae (cyanobacteria) and Red Tide (Karenia). Thus, the treated water may be used for various purposes such as cleaning and/or treating of various water sources or volumes to assist in cleaning and making them safer for human or other animal consumption and/or contact and to assist in various activities such as disease, virus, and bacteria control and/or growth augmentation agriculture and/or aquaculture.

The infusion system 20 may include various components to allow for the inflow and outflow of a fluid including a liquid. In various embodiments, the liquid may be water. The mixing system 20 further includes components that allow and/or control inflow of a gas, such as a plasma-activated gas. The plasma-activated gas may be generated by any appropriate system, including those discussed further herein. Additional exemplary plasma-activated gas generation system may include a PAG generator 28, as illustrated in FIG. 5. The PAG generator 28 may include a generator portion 32 housed within a housing 34. The PAG system 28 may include that described in U.S. Pat. Nos. 10,797,472 and/or 10,032,593 both to In Ho Lee et al., all of the above incorporated herein by reference. As noted above, however, additional and/or alternative PAG generation systems may also be included such as those disclosed in U.S. Pat. No. 9,352,984 and U.S. Patent Application Publication 2016/0102025, all of the above incorporated herein by reference. Nevertheless, the PAG may also be generated with the system as discussed further herein.

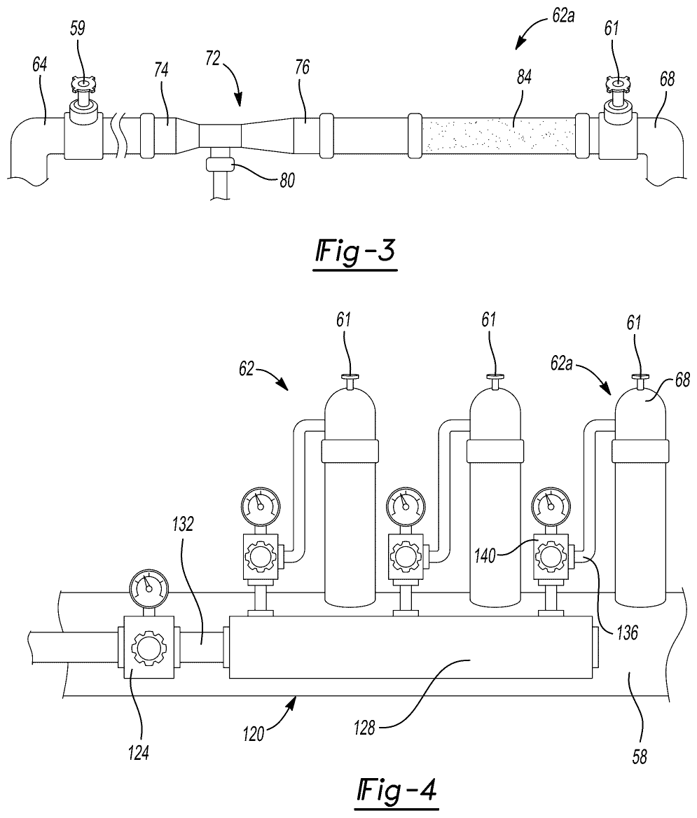

The PAG, however, may be infused into a selected volume of a liquid, such as water, as noted above, with the infusion system 20, as illustrated in FIGS. 1, 2, 3, and 4. The infusion system 20 may be powered by a pump, such as a submersible pump 40 that is positioned within the container 24 and/or other appropriate volume. According to various embodiments, the pump 40 may be positioned within an internal container 41 within the container 24. The liquid may overflow or fill into the container 41 and is then pumped with the pump 40 to the inlet 44.

The target constituent may be more or less dense than water. The liquid to be treated may be collected from the area expected to have the highest concentration. Similarly, the target constituent may be concentrated at the surface because of dissolved air floatation and/or foam fractionation. The inlet can be modified (e.g., moved or positioned) to capture either the bottom liquid or the surface liquid to provide preferential treatment through multiple infusions of PAG to the most concentrated contaminants. It is understood that the pump 40 need not be a submersible pump but may also be a dry pump that is positioned external to the volume, such as the container 24, and powers a flow of fluid, such as liquid including water, through the infusion system 20 while drawing water from the container 24 and through the infusion system 20. However, the submersible pump 40 allows for a compact system, such as the self-contained PAG infusion system 25, illustrated in FIG. 1. As noted above, a self-contained infusion system 25 is not required, however, the self-contained infusion system 25 may allow for portability and production of a plurality of systems for various applications that may be efficiently moved from location to location and/or manufactured for purchase at selected locations.

The self-contained system 25 may allow for the submersible pump 40 to pump water within the container 24 to an infusion inlet 44. The infusion inlet 44 may be connected to the submersible pump 40 through a connection, such as any appropriate fluid connection 48. The submersible pump 40 may be powered through any appropriate power mechanism such as a power cord, an internal power system, or other appropriate power system. The submersible pump 40 may pump water through the connection 48 to the infusion inlet 44. The infusion system 20 may then include an outlet 52 to allow the water that has been infused with a plasma-activated gas to reenter the container 24. The outlet can include a device to minimize the discharge of excess (non-dissolved) PAG as bubbles to increase the amount of gas delivered and improve the treatment process.

The self-contained infusion system 25 may allow for a recirculation of liquid, such as water, from the container 24. The average number of passes (through recirculation) is controlled by the rate at which untreated water is introduced into container 24 and can be varied to account for the treatability of the species of interested in the targeted water. Various operation parameters may be augmented or changed based upon a selected application for the plasma-activated infused water in the container 24. Various parameters that may be adjusted include a flow rate of gas to the infusion system 20, flow rate and pressure of water through the infusion system 20, a concentration of selected species in the gas to the infusion system 20, and other appropriate parameters.

Varying the influent rate into container 24 varies the number of times the water volume is re-infused with PAG allowing the PAG and its byproducts, including ozone, to become supersaturated in containers 24 even as the treated water consumes the radicals generated by the PAG. The number of recirculations, which can increase the PAG concentration in the liquid, is increased for highly concentrated influent (i.e., concentrated with the species of interest) and/or difficult to destroy chemicals. Also, as noted above, the system may include modifications to capture and recirculate surface liquid (e.g., water) take advantage of dissolved air flotation and/or foam fractionation.

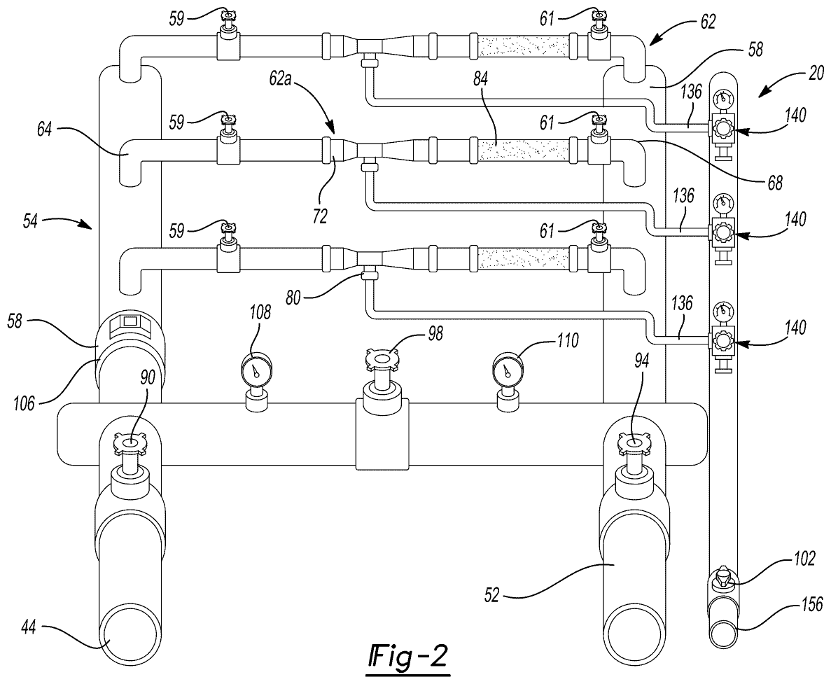

With continuing reference to FIG. 1 and additional reference to FIGS. 2-4, the infusion system 20 will be described in further detail. In various embodiments, the infusion system 20 need not be connected directly to the container 24 for the self-contained infusion system 25. Accordingly, the infusion system 20 as discussed further herein, will be understood to be operable with an appropriate volume of liquid, such as water, which may include the container 24 or other appropriate volumes, or other appropriate volumes. For example, the infusion system 20 may be hydraulically connected to a pond, such as a wastewater treatment tank, for treatment of the water therein.

The infusion system 20 includes the inlet 44 and the outlet 52. The infusion system 20 further includes an inlet manifold 54 and an outlet manifold 58. The manifolds 54, 58 allow for equally distributing pressure and flow and positioning of one or more infusion portions 62 between the two manifolds 54, 58. Any appropriate number of infusion portions 62 may be provided based upon selected parameters, such as a desired volume of gas to be infused, the concentration of the infused gas, a volume and rate of water to be treated, the concentration of the species of interest, the difficulty of treatment of the species of interest, a flow rate through the infusion system 20, or other selected parameters including the quality of the influent and the required effluent quality. For each of the infusion portions may be an inlet valve 59 and an outlet valve 61. Thus, each infusion portion 62 may be individually controlled. Also, the valves 59, 61 may include pressure and/or flow meters. Also, they may be automatically controlled. The infusion portions 62 may be one or more of a venturi injector, an aeration device, and/or a gas dissolution pressure tank.

Exemplary operation conditions may include a continuous waste stream of highly PFAS contaminated landfill leachate Reverse Osmosis reject water. This leachate water may be treated at a rate of 1,500 gallon per day, utilizing 16 infusers portions, each delivering between two to three liters per minute of PAG per infuser, using air as a carrier gas, delivering PAG with an Ozone content exceeding 5 parts per million (ppm). The treated effluent met federal guidance (PFOA+PFAS<70 part per trillion (ppt)), Michigan groundwater standards (PFOS<16 ppt and PFOA<8 ppt), and all but one of the Michigan Drinking Water Standards. Of fifteen detectable PFAS constituents, nine were destroyed (below the detection limit), and six were reduced. Similar results were demonstrated on identical wastewater operating at a treatment rate of 3,000 gallons per day. Thirteen of the PFAS constituents were detectable in the influent. Eight of the detectable constituents were destroyed (below detection limits), and five were reduced. Without being bound by the theory, and only as an example, when this same waste stream is partially treated PFAS constituents can be disassociated and recombine as a different PFAS constituent. For example, when the same waste stream was treated at a rate of 7,600 gallons per day with three infusers injecting PAG using air as carrier gas and another three infusers injecting PAG using argon as a carrier gas, results did not achieve the same rates of reduction. Of the twelve detectable constituents, one constituent was destroyed, five were reduced.

As one skilled in the art will understand, therefore, the infusion portion 62 may include a plurality of individual infusion portions 62a having substantially similar components, such as those discussed further herein. Accordingly, discussion of the single one infusion portion 62a will be understood to be replicated by the other infusion portion and the discussion of a single one of the infusion portion 62a is merely exemplary.

Each infusion portion 62a, therefore, may include a water inflow conduit 64 that allows flow of water from the inlet manifold 54 into the infusion portion 62a. The infusion portion 62a further includes an outflow portion or conduit portion 68 that allows flow of water from the infusion portion 62a to the outlet manifold 58. In this way, water may flow into the infusion portion 62a and through an infusion member 72.

The infusion member 72 may be any appropriate infusion member, such as a Mazzei® injector venturi port sold by Mazzei Injector Company, LLC having a place of business in Bakersfield, California. Various exemplary Mazzei® injector ports include the model number 584 that includes an inlet side 74 and an outlet side 76. Between the inlet and outlet sides 74, 76 is a barb 80 that may be a gas connection, as discussed further herein.

Downstream of the infusing member 72, such as downstream of the outlet 76, may be a viewing or inspection port or portion 84 of the infuser portion 62a. The inspection portion 84 may allow for visual inspection of a flow of material past the infusion member 72. The inspection port 84 may allow for inspection of the passage of debris, the presence of bubbles, the presence of turbulence, or other visual features in the flow. It is understood that the visual inspection may be automatic and/or manual, such as with a user. An automatic inspection may include a camera system, a bubble monitor (such as a Siansonic Air Bubble Detector), or a solids monitor (such as a Pyxis RT-100 PRISM inline Refractometer) and various appropriate associated processor systems to visually inspect the flow in the inspection portion 84.

Accordingly, the infusion portions 62 may include one or more of the infusion portion 62a. The infusion portion 62 allow for a passage of the liquid, such as water, from the inlet manifold 54 to the outlet manifold 58. The infusion portion further includes a flow path of the fluid, such as water, to and/or through the infusion member 72. This process and/or directed flow may allow for concentration of selected radicals in the PAG to be controlled, optimized, maximized, and/or otherwise controlled.

The infusion system 20 may further include various controls such as an inlet or influent control valve 90 that may be used to control or stop flow into the infusion system 20. In various embodiments, various valves and couplings can be included to allow for isolation, removal, and repair of individual infusers without eliminating flow to the other infusers. The infusion system 20 may include an effluent or outflow valve 94 such as to control outflow from the infusion system 20. The infusion system 20 may include a bypass valve 98 that allows for a passage of fluid between the inlet 44 and the outlet 52 to control the flow rate and pressure drop of the fluid flowing through the infusion portions 62.

The infusion system 20 may further include a gas valve 102 that controls a flow of gas into the infusion members 72 such as via the gas inlet 80, as discussed further herein. Accordingly, various valves or controls may be used to control a flow of liquid to the infusion portion 62 from the inlet 44 to the outlet 52. Also, a gas control 102 may control the flowrate of gas to the individual infusion member 72. Again, as discussed above, any appropriate fluid may be used to be infused in the infusion system 20. In various embodiments, the fluid that flows through the inlet and outlet 44, 52 may be a liquid and a gas through the gas inlet 102. In various embodiments, including those discussed further herein, the fluid flowing through the inlet and outlet 44, 52 may be water and the gas may be PAG. The rate of flow and/or the on and off of the flow of the PAG may be controlled with the valve 102.

The infusion system 20 may further include various meters or sensors, such as a flow meter 106 to sense or detect flow volume and rate of the water through the infusion system 20. Additionally, one or more pressure gauges, such as a first pressure gauge 108 upstream of the bypass valve 98 and a second pressure meter 110 downstream of the bypass valve 98 may be provided to, select, including optimize gas delivery. The flow meter 106 may be used to determine a flowrate and volume through the infusion system 20 of the water (Micronics U1000 Clamp on Flow Meter). The pressure sensors 108, 110 may be used to optimize gas delivery by controlling the pressure within various portions of the system, such as on an inlet or outlet side.

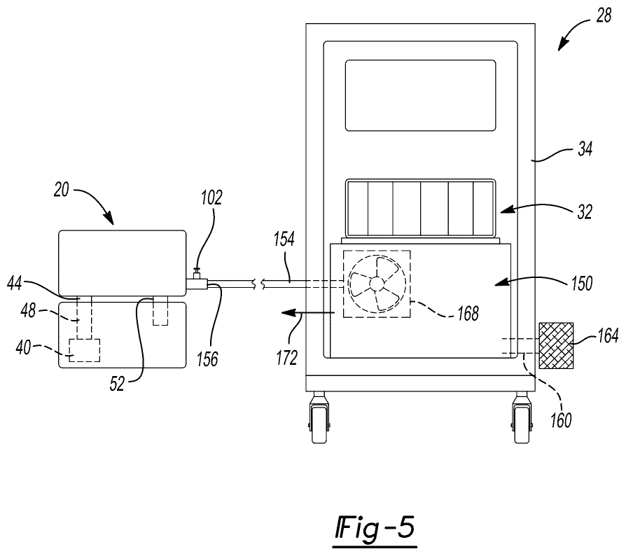

With continuing reference to FIGS. 1-3 and additional reference to FIG. 4, the infusion system 20, including the infusion portion 62, may include a gas supply system 120 having an inlet 156 from a gas source, such as Plasma Activated Gas (PAG) as discussed herein. The gas supply system may initially receive gas through the gas shutoff valve 102 into an initial or main flow control regulator and/or meter 124. The main regulator 124 may allow for regulation of a flow to a gas distribution manifold 128 for the gas. The gas manifold 128 allows for distribution of a supply of gas to all of the infusion portions 62 including each of the individual infusion members 72. The gas may flow from the main regulator 124 through a first conduit 132 to the manifold 128. From the manifold 128, gas may flow to each of the individual infusion members 72 via an outflow conduit 136.

The outflow conduit 136 may initially be connected to an individual regulator and/or flow meter 140. The individual regulator flow meter 140 allows for a regulation and flow determination to each individual infusion member 72 and to distribute the gas, such as equally, between multiple infusion members 72. Therefore, an inflow to the manifold 128 may be regulated by the main regulator 124 and a flow to each of the individual infusion member 72 may be regulated by the individual regulators 140. Thus, a gas flow to each of the individual infusion portion 62 may be separately measured and/or regulated.

According to various embodiments, the gas, including the PAG, may be provided to the infusion portions at a selected pressure. The pressure may be appropriate for the selected system, including the infusion members 72. In various embodiments, however, the pressure may be about 50 psi to about 500 psi, including about 100 psi to about 300 psi.

The gas flow rates that are measured with the flow meters 124, 140 may be automatic and/or manual. In various embodiments, for example, a digital flow meter may be used to measure a flow and data may be collected with a processor module. Further, the flow meters and regulators 124, 140 may also be manually adjusted and/or automatically adjusted. For example, a selected flow rate may be determined for operation of the infusion system 20. Therefore, the flow meters and regulators 124, 140 may be monitored and/or adjusted to achieve a selected flow rate to each of the individual infusion member 72 of the infusion portion 62. Flow monitors and/or controllers may be automated and control the processor modules. Exemplary automated liquid flow systems include Micronics U1000 Clamp on Flow Meter and gas flow rate systems include Bronkhorst Flexi-Flow meter. These monitors allow automated matching of water flows with gas delivery as well as remote monitoring of operation and further allows fouled infusers to alarm and allow the individual infuser to be taken offline and the gas delivery to be redistributed to the functioning infusers until maintenance can be performed.

Each of the infusion members 72 may be or include a venturi style differential pressure injector. Accordingly, the flow of the water through the infusion system 20 may provide a selected force to draw the PAG into the water as it passes each of the individual infusers 72. This design, according to various embodiments, also allows the PAG to be delivered under pressure for increased gas concentration (including super saturation) and increase dissolved PAG delivery at point of delivery. Therefore, a flow rate of water may change or adjust a flow of the gas into the infusion member 72. In turn, control of the inlet and outlet valves 90, 94 and/or the submersible pump 40 may be selected and controlled to control a flow of the gas into the individual infuser 72. Again, each of these controls may be controlled with a processor module to assist in maintaining or achieving a selected flow rate of the water through the infusion system 20 and/or gas into the infusion system 20.

Returning reference briefly to FIG. 1, the infusion system 25 may further include a separate and/or complementary gas infusion system. The secondary or complementary gas infusion system may receive water via a conduit 52′ including some or all of the outlet liquid from outlet 52 of the gas infusion system or act independently and withdraw water from the tank 24. The complementary gas infusion system may include an inlet 156′ that may also receive the PAG from the generator, similar to the inlet 156. The PAG may flow to a containment system or area 159 that may include one or more nozzles or outlets 161. The outlets 161 discharge a selected volume of supersaturated water with a selected size of bubbles. The bubbles may include a selected size, such as at nanometer diameter sizes, as discussed herein. The bubbles generally flow in the direction of arrow 167. The gas bubbles that include PAG from the inlet 156′ further incorporate gas into the volume of liquid within the container 24. Therefore, the infusion system 25, including the infusion portions 62 may be enhanced and/or augmented by the further infusion by the gas from the nanometers bubbles from the inlets, which may be tubes, 161.

The system including the tank 24 may further include a water liquid inlet 24i and an outlet 24o. The inlet 24i may allow for an influent at a selected rate of the liquid into the tank 24. The outlet 24o may allow for a selected effluent rate of the liquid from the container 24. Thus, the system may include a selected flow rate of liquid through the container 24 which may be selected to ensure a selected concentration of PAG, PAL, GAL, or combinations thereof.

The process described herein may improve, according to various embodiments, the gas delivery by infusing PAG and delivering that gas as a micro- or nano-bubble. The amount of PAG delivered can be increased using micro- or nano-bubble, without being bound by the theory, because the surface area of the gas/liquid interface is increased several orders of magnitude and micro- or nano-bubbles will have much longer contact time with the liquid. For example, because buoyancy is small, nanobubbles, in particular, are sufficiently small that bubbles do not rise but rather behave in a manner similar to Brownian motion. An additional benefit is the increase in the generation of hydroxyl radicals (OH⁻) caused by bubble collapse. As gas leaves the bubble to dissolve in the liquid (and become available for treatment or acting on the selected species), the bubbles shrink and eventually collapse causing an energy discharge leading to additional radicals for treatment of the selected species. Because one microbubble delivers the same volume of gas as 1 million nanobubbles, nanobubbles are expected to generate a million more collapses and a corresponding number of additional radicals.

The efficiency of gas-liquid transfer can be improved using bubbles of a selected size, such as micro bubbles and/or nanobubbles. The bubbles may have an average or maximum diameter of about less than 100 nanometers (nm) to about 200 microns, including about 100 nm to about 100 microns, and further including less than about 100 nm and less than about 50 microns. In various embodiments, nanobubbles may be bubbles that are generally less than 100 nanometers (or 0.1 micron) or less and may increase a transfer because the mass transfer rate of a gas depends on the mass transfer area of the gas-liquid phases which are much higher for nanobubbles and accordingly can cause the gas dissolution rate in water to reach supersaturation state. Additionally, the number of bubbles available for collapse is several orders of magnitude higher for the same volume of gas delivered. Bubble collapse causes the disappearance of the gas-liquid interface, and during the process of nanobubble self-pressurizing, an extremely high concentration of charged ions is accumulated at the interface to that will instantly release chemical energy that generates hydroxyl radicals (OH⁻). This further contributes to the chemical oxidation of the PAG infused wastewater.

Micro/nanobubbles can be generated in a number of ways such as disclosed in “A critical review of the recent developments in micro-nano bubbles applications for domestic and industrial wastewater treatment”, Sakr, Mohamed, Maraqa, Hamouda, Hassan, Ali, Jung, Alexandrria Engineering Journal, 61:8, pp 6591-6612 (Feb. 2, 2022) at www.sciencedirect.com/science/article/pii/S1110016821007742?via%3Dihub. Additional and/or alternative methods include venturi infusion, water vortex microbubble generation, and pressurization followed by depressurization such as that described in U.S. Pat. No. 9,308,505, incorporated herein by reference.

The PAG generator 28 can include various systems, such as those discussed above. For example, the PAG generator 28, as illustrated in FIG. 5, may include the PAG generation portion 32. The PAG may be collected or originally generated in a PAG volume 150. The PAG volume 150 may include an initial volume of the PAG generated by the PAG generator 28. The PAG from the PAG volume may be transported from the PAG volume 150 to the infuser system 20. In various embodiments, an outlet conduit 154 may connect to the PAG volume 150 and the infuser 20, such as at an inlet 156 wherein the control valve 102 may control flow of the PAG to the infuser system 20. As discussed above, the individual infuser member 72 may operate on a venturi differential pressure injector system such that flow of the water through the infuser system 20 causes flow of the PAG through the conduit 154 from the PAG volume 150.

The PAG may be generated, as discussed above, and may require afresh supply of gas, such as atmospheric air. Accordingly, an air conduit 160 may allow inlet or inflow of air into the PAG volume 150. The air may be atmospheric air and, therefore, may be filtered through a filter 164 before entering the conduit 160 to enter the PAG volume 150. Thus, the PAG generator 28 may generate the PAG for being transferred to the infuser system 20.

The infuser system 20 may operate with the Venturi differential pressure injector system, such that the flow of the water may cause or provide a force to cause the PAG to be drawn into the infuser member 72. In addition, and/or alternatively thereto, it is understood that the flow of the PAG from the PAG generator 28, including the PAG volume 150, may be active due to a pump, fan 168, compressor, or the like to provide a selected flow and pressure through the outlet conduit 154 to the infuser 20. Thus, the PAG may flow from the PAG volume 150 generally in the direction of arrow 172 from the PAG volume 150 to the infuser 20.

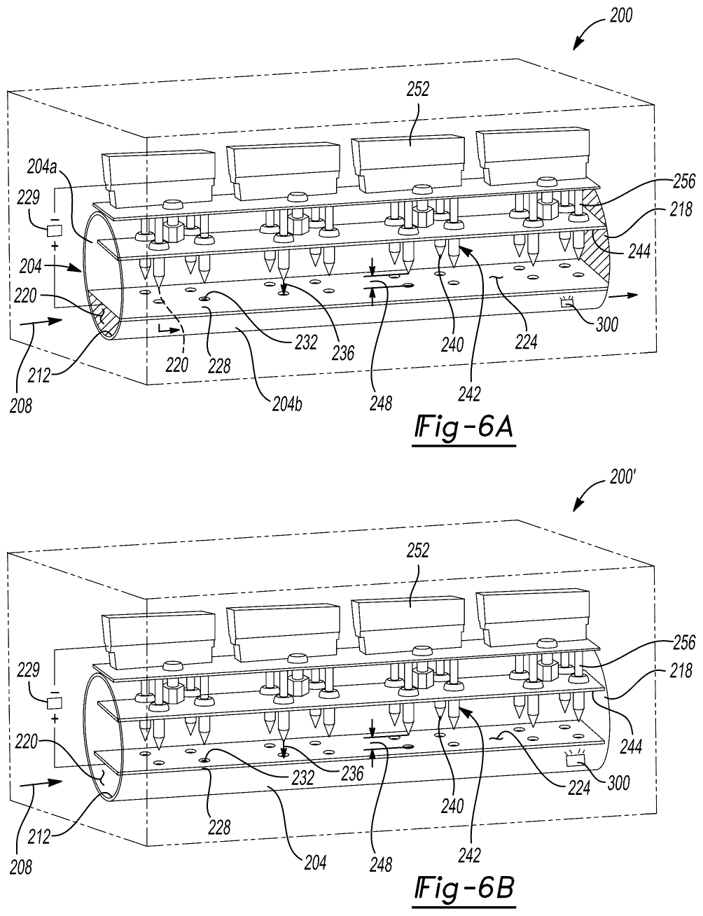

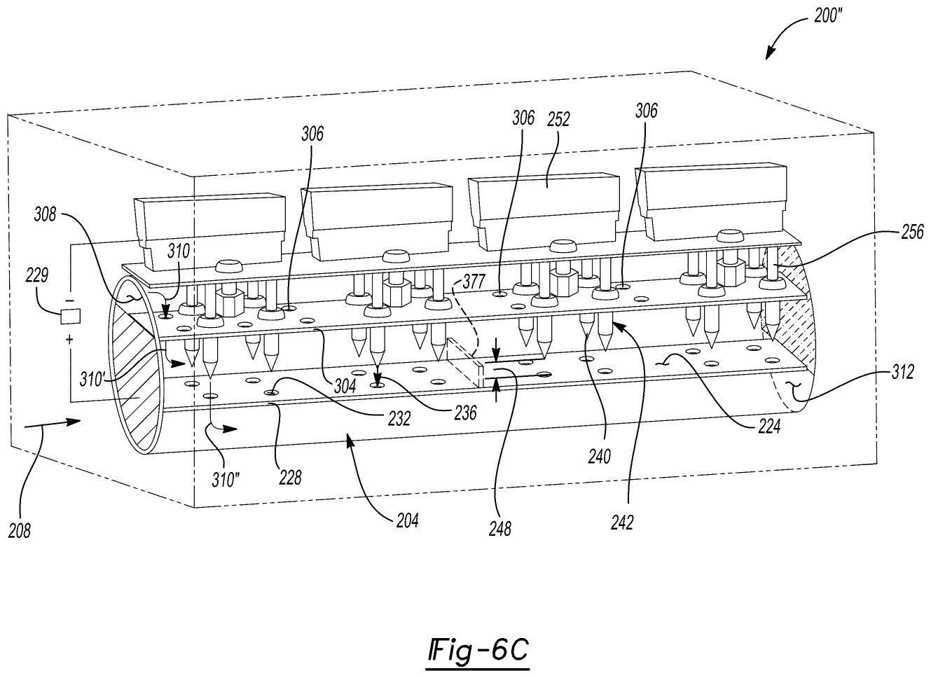

Turning reference to FIG. 6A, according to various embodiments, a PAG generator 200 is illustrated. The PAG generator 200 may include various portions similar to the PAG generator 28, discussed above. The PAG generator 200, however, may include an operation that differs from the PAG generator 28 and allows for a continuous flow of gas through the PAG generator 200 without requiring a PAG volume 150, as discussed above.

Turning reference to FIG. 6B, according to various embodiments, a PAL generator 200 is illustrated. The PAL generator 200 may include various portions similar to the PAL generator 28, discussed above. The PAL generator 200, however, may include an operation that differs from the PAL generator 28 and allows for a continuous flow of liquid through the PAL generator 200 without requiring a PAG volume 150, as discussed above.

According to various embodiments, the PAG/PAL generator 200 is designed to operate under pressure, closer to a gas mixing (e.g., infusion) location in a larger treatment operation. The PAG/PAL generator 200 may include any appropriate length and PAG/PAL generation portions, as discussed herein, for placement in a PAG/PAL system. The PAG/PAL generator 200, however, may provide a streamlined and in situ configuration compared to the PAG generator 28.

The PAG/PAL generator 200 may include a housing or channel wall 204. The channel 204 may include one or more portions that are separated, as discussed herein. For example, when generating activated gas, the channel 204 may include a first or corona portion 204a that allows for a flow of gas generally in the direction of arrow 208. The channel 204 may further include a secondary flow portion 204b for generated PAG. The flow of gas may enter at an inlet end 212 of the channel 204 in the corona portion 204a and exit at an exit end 218 of the channel 204 in the secondary flow portion. To achieve this, the gas must pass through the plate 228. It is understood that the PAG generator 200 may include any appropriate length and/or that a PAG generator includes a plurality of the channels 204. Nevertheless, the single example will be discussed here. The channel 204 may also be positioned within a housing or cabinet, 219, if selected.

In FIG. 6A, the channel 204 has a substantially unobstructed flow path 220 from a PAG generation volume or area 224 in the channel portion 204a to the outlet portion 204b. The flow path 220 of the channel 204 may be separated such that the inlet portion 204a near the PAG generation volume 224 is separated from the outlet portion 204b by a plate 228. The plate 228 may be grounded, as discussed further herein, and/or electrically isolated from a voltage source 229. The plate 228 may include one or more passages 232 to allow charged particles, such as electrons and/or other species including PAG, to pass from the generation area 224 to the outlet portion 204b, such as generally the direction of arrow 236. The passages may be sized for selected purposes, such as the specific voltage applied and/or the volume of gas flow, etc. The size of the passage may include a cross-section area of about 0.1 millimeters squared (mm²) to about 100 mm², including about 0.1 mm² to about 10 mm², and further including about 10 mm².

In both FIGS. 6A and 6B, spaced away from the plate 228 may be one or more generation points 240 of generation members (also referred to as pins) 242 that extend from a support 244 a selected distance 248 from the plate 228. The distance 248 may be selected for various purposes, as discussed further herein. For example, the distance 248 may be about 0.1 mm to about 20 mm, including about 3 mm to about 10 mm, and further including about 8 mm. The generation members 242 may also include a selected cross-sectional dimension such as about 1 mm to about 20 mm in diameter.

The generation point 240 is electrically connected to a power source or power transmission source 252 through an electrical connection 256. The power source 252 may provide a selected or cause a selected voltage at the generation point 240. The voltage causes a generation of corona around the point or relative to the point 240. The voltage can be generated by taking low voltage, low power, such as from a 12 volt, 26.7 amp universal DC power supply (XP Power LCW320PS12) and multiplying the voltage using an astable multivibrator to generate an appropriate voltage such as about 9,000 volts, including about 5,000 volts to about 15,000 volts. In various embodiments, a selected voltage is delivered to the point 240, using an astable multivibrator or equivalent. The placement and distances of the pins and plate can be varied but, in various embodiments, the voltage is elevated to 9,000 volts and is directed to a pin centered above a 10 millimeter hole on the plate 228. The corona caused at the point 240 may generate electrons that are accelerated toward the plate 228 as the plate 228 may be charged positively, such as by connection to the power source 252 as schematically illustrated in FIG. 6.

In FIG. 6B, As the electrons are accelerated to the plate 228 at least a portion may pass through the bores or holes 232 to enter the channel 220. As air passes through the channel 220, the electrons may cause the formation of selected ions or other appropriate species in the gas as it flows through the channel 220. The gas flowing through the channel 220 may therefore become the plasma-activated gas (PAG) that exits the exit end 218 for a selected purpose. As discussed above, the exit 218 may be connected to the infuser 20 for infusion of the PAG into water, as discussed above.

The generation of the PAG in the PAG generator 200 may be altered according to various parameters. In one embodiment, the number of points 240 may be selected (e.g., increased), to select or increase the number of coronas in a region. This may increase the amount (e.g., concentration) of radicals in the region and generated for a given volume of fluid, such as gas. For example, the voltage applied with the power source 252 may be varied. The distance 248 of the point 240 from the plate 228 may be altered or adjusted to assist in causing a higher number or concentration of electrons accelerating through the passages 232. The size of the passage 232 may also be altered or adjusted. The passage 232 and/or other portions, such as the plate 228, may be insulated to minimize electron loss after passing through the corona. The pressure under which it is operated may increase as a method of increasing the saturation concentration of the generated gases—notably ozone. Other parameters may include a flow rate of the gas through the tube 204 to either increase a flow and movement of electrons through the PAG generator 200 and/or allow a greater dwell time of a selected volume of a gas to allow for a greater number of electrons to disrupt the oxygen and/or nitrogen in the carrier gas thereby making the resulting PAG more aggressive in attaching the target pollutant.

According to various embodiments, PFAS can be destroyed (below detection) when treated with PAG, PAL, GAL, or combinations thereof. For example, the GAL or PAL may interact with the PFAS. Alternatively or additionally, the PAG in a bubble may interact with the PFAS. Regardless of the interaction, PFAS may be lowered to undetectable concentrations. However, if a concentration of the selected species (e.g., the generated species) in the PAL, PAG, and/or GAL concentration is insufficient and/or the residence time is insufficient, PFAS can be disrupted but then recombine to form other, shorter-chain PFAS. For example, when a continuous waste stream of highly PFAS contaminated landfill leachate Reverse Osmosis reject water was treated at a rate of 1,500 gallon per day, utilizing 16 Venturi differential pressure injector infusers, each delivering between two to three liters per minute of PAG, using air as a carrier gas, delivering PAG with an Ozone content exceeding 5 ppm. The treated effluent met federal guidance (PFOA+PFAS<70 ppt), Michigan groundwater standards (PFOS<16 ppt and PFOA<8 ppt), and all but one of the Michigan Drinking Water Standards. Of fifteen detectable PFAS constituents, nine were destroyed (below the detection limit), and remaining six were reduced. Similar results were demonstrated on identical wastewater operating at a treatment rate of 3,000 gallons per day. Thirteen of the PFAS constituents were detectable in the influent. Eight of the detectable constituents were destroyed (below detection limits) and remaining five were reduced.

In various embodiments, without being bound by the theory, the corona at the points 240 cause electrons to be freed and/or generates free electrons that may accelerate through the bore 232 in the plate 228. Generally, the material of the plate 228 and the pins 242 is conductive, but once the PAG is generated and passes through the holes 232, the tubing and the underside of the plate 228 can be insulated to minimize the loss of charged radicals. These electrons may interact with various chemical species in the air to change those species. For example, oxygen or nitrogen radicals may be formed, hydroxyls may be formed, and/or other appropriate or selected chemical species may be formed due to the presence of the energized electrons. The gas passing through the PAG generator 200 therefore becomes plasma-activated gas with the selected chemical species, including radicals therein. The PAG may be mixed with a liquid, such as water, to become GAL.

The amount or concentration of the selected generated species, such as the radicals may be based on various parameters such as the number of coronas and the volume of fluid (e.g., gas) flowing past the coronas. The parameters may be adjusted to achieve a selected concentration at a selected time. Again, without being bound by the theory, a set flow rate may achieve a set or selected concentration of the radicals. A higher flow rate, higher than a theoretical set flow rate, may relatively dilute the radicals generated in the PAG due to the speed and minimal dwell time of species that might be affected by the electrons within the PAG 200. A lower flow rate, lower than the theoretical set flow rate, however, may also not allow a large enough number of particles for exposure to the electrons before the electrons are either absorbed into the casing 204, the plate 228, or may deliver a larger portion of non-activated species. A flow rate of about 0.01 liters (L) per pin to about 1 L/pin, including about 0.1 to about 0.5 L/pin, and further including about 0.25 L/pin may achieve a concentration of ozone that is at least 100 parts per million (ppm). By controlling the flow rate of the fluid (e.g., gas) through the coronas, a concentration of ozone in the fluid can exceed 500 parts per million (ppm) which also exceeds the solubility of ozone at standard temperature and pressure in atmospheric gas (109 ppm).

Turning reference to FIG. 6B, a generator 200′ is illustrated. The generator 200′ may be substantially identical to the generator 200, discussed above. The generator 200′, however, includes the channel 204 that is unobstructed and allows a flow of liquid through beneath the plate to 228. The generator 200′, however, may be operated substantially identically to the generator 200 as discussed above.

The PAG/PAL generator 200 may include a housing or channel wall 204. The channel 204 may include one or more portions that are separated, as discussed herein. The channel 204 may further include a flow portion 220 for generated PAL. The flow of liquid may enter at an inlet end 212 of the channel 220 and exit at an exit end 220 in the secondary flow portion. To achieve this, the liquid must pass below the plate 228. It is understood that the PAG generator 200 may include any appropriate length and/or that a PAG generator includes a plurality of the channels 204. Nevertheless, the single example will be discussed here.

In FIG. 6B, as the electrons are accelerated to the plate 228 at least a portion may pass through the bores or holes 232 to enter the channel 220. As a liquid passes through the channel 220, the electrons may cause the formation of selected ions or other appropriate species in the liquid as it flows through the channel 220. The liquid flowing through the channel 220 may therefore become the plasma-activated liquid (PAL) that exits the exit end 218 for a selected purpose.

The PAG and PAL may be used for various purposes, such as generating oxygen and nitrogen radical gas—including ozone—for use as a gas or to be infused into a liquid, such as water, as discussed above, to generate the GAL. The water may be used for various purposes such as for cleaning the water by direct application of the PAG to the water such as through the infusion process discussed above and/or mixing of the infused water with other water sources. This may be used to destroy or neutralize various chemical species, such as PFAS. The activated gas and/or infused water (GAL) may also be used for killing or inactivating various biological species such as bacteria, fungus, and/or viruses as well as destruction and/or control of blue green algae (cyanobacteria) and/or red tide (Karenia). This may assist in decreasing pathogen growth, controlling odors, and other purposes. The destruction of selected chemical species and/or for killing or neutralizing various organisms may assist in enhancing desired growth (e.g., agriculture) and reducing undesirable growth such as in the food packaging, food processing facilities, and the like.

The PAG/PAL may also be applied directly onto various surfaces. For example, the PAG may apply directly to an air transport system to assist in neutralizing and/or destroying chemical species and/or organisms on plant surfaces, such as leaves. This may assist in cannabis growth operations, aquaculture, and other purposes. Further the PAG/PAL may be applied to surfaces to assist in disinfecting the same.

The system, according to various embodiments as discussed herein, may be used to generate PAG and/or plasma activated liquid PAL. The PAL and/or PAG may be an effective treatment for destruction of VOCs, removal of metals, total suspended solids, organic carbon and many, many more as well as significant reductions to chemical oxidation demand (COD). Additionally, PAG is used for disinfection in food processing operations, disinfection, odor control, plant growth stimulation, virus, fungus, and bacteria control in hydroponics operations.

In addition to the PAG generator 28, 200, as discussed above, various other systems may also be added to assist in various cleaning and/or sterilization applications. For example, an ultraviolet generator, such as an ultraviolet light 300, may be added within the casing 204 to further assist in sterilizing or cleaning the flow through the PAG generator 200.

With reference to FIG. 6C, a generator 200″ is illustrated. The generator 200″ may be similar to the generators 200, 200′ described above. Therefore, similar elements will have the same reference numerals as used above. The generator 200″, however, may include a gas flow direction system that allows for directing or flowing a gas in a selected or specific manner relative to the generator members 242 including the generator points 240. For example, the gas may flow generally in the direction of arrow 208. The gas may flow from an inlet portal 308 into the housing 204 of the generator 200″.

The generator 200″ may have the generator members 242 extending or supported by selected support member 304. The support member 304 may include or support the generator members 242 or be provided to assist in directing or providing passages 306 therethrough. As illustrated in FIG. 6C, the entry or inlet portal 306 allows or limits gas inlet to an area at or near the generator points 240. Passages or portals 306 may be formed in the support 304. The passages 306 may be positioned substantially adjacent or near the generator members 242 such that a gas that enters the input portal 308 is forced through the portals 306 in the support 304. Therefore, the flow of gas may initially and generally be in the direction of arrow 208, but may have a specific direction or path such as indicated by the arrows 310 within the housing 204. For example the gas may first pass through the portals 306 of the support 304 generally in the direction of arrow 310. Thereafter the gas may flow through the housing 204 generally in the direction of arrow 310′ and/or pass through the second portal 232 in the direction of arrow 310″. The gas may continue to flow through or to an outlet 312 at an outlet end or side of the housing 204. Therefore, the gas flow may generally be in the direction of arrow 208 but may have a flow path within the housing 204, such as relative to the generator members 242 and points 240 thereof, as discussed above.

Therefore, the inlet gas may generally be forced to pass adjacent to or over at least one of the generators 242 including the points 240. As discussed above, the point 240 maybe used to generate a corona (e.g., cold plasma). Electrode plate 228 may assist in ensuring direction of electron from the corona to assist in ensuring that electrons engage the molecules within the gas to generate or form the selected species, as discussed above.

One skilled in the art will understand that the generator, according to various embodiments, including the generator 200″ may include various turbulence inducing and/or directing structures to ensure passage of the gas through or adjacent to coronas formed by the generators 242. The selected dispersion or directing holes 306 formed in the support 304 may be formed in any appropriate configuration. For example, a separate or distinct dispersion plate may be provided or formed to direct or cause a flow of a gas or fluid in a selected manner nearer adjacent to a corona generated by the generator members 242, such as that or near the points 240. The direction of the flow of the fluid or gas may assist in ensuring an appropriate concentration of generated species within the gas that exits the generator 200″.

The systems according to various embodiments may be operated to achieve selected results. For example, for difficult to destroy, complex organic chemicals, such as PFAS, repeated infusion of high concentration PAG may be used to fully destroy the target chemical or target species. In the case of PFAS, the chemical may disassociate with the introduction of PAG, but the fragments of chemical will recombine to form other smaller chain PFAS. Repeated infusion of PAG destroys the molecules and the concentration of the entire family of PFAS becomes below detection limits. The repeated treatment with PAG may be by provided a plurality of infusers in series and/or several as ones as illustrated above. In various embodiments, a bulk volume of contaminated liquid may be treated and bulk treated serially to achieve selected results.

For less complex treatment, like destruction of Blue Green Algae (Cyanobacteria) or Red Tide (Karenia), the number of treatment steps may be reduced to as low as one. The introduction of PAG or PAL will destroy the live biological species of concern and once destroyed, it will not regenerate. Thus, if the amount and concentration of PAG is sufficient to inactivate all of the biological species, a single pass may suffice.

Moreover, the PAG alone may be introduced into an environment. For example, in a packaging center, PAG may be introduced into the environment, such as with a HVAC system, to assist in cleaning and/or sterilizing items to be packaged. This process may also control and/or eliminate air borne diseases including bacteria such as legionella (causing a type of pneumonia known as Legionnaires' disease). This may enhance and/or increase longevity, cleanliness, etc. of packaged items such as food. Similarly, PAG may be introduced onto plants or other surfaces to decrease and/or eliminated selected species.

PAG may be generated and mixed with a selected liquid, such as water from any appropriate source. The PAG mixed with a liquid may become GAL—a form of PAL, as noted above. Thus, PAL may be formed by mixing PAG with a liquid. In various embodiments, however, PAL may be generated by directly activating various chemicals or compounds within a liquid, such as water from an appropriate source. As understood by one skilled in the art, a liquid or a gas may be also referred to as a fluid. In other words, an activated chemical species may be first generated in or from a gas (e.g., atmospheric air) and mixed with a liquid or generated within a liquid directly or initially. Various embodiments include those discussed above and below, and combinations thereof.

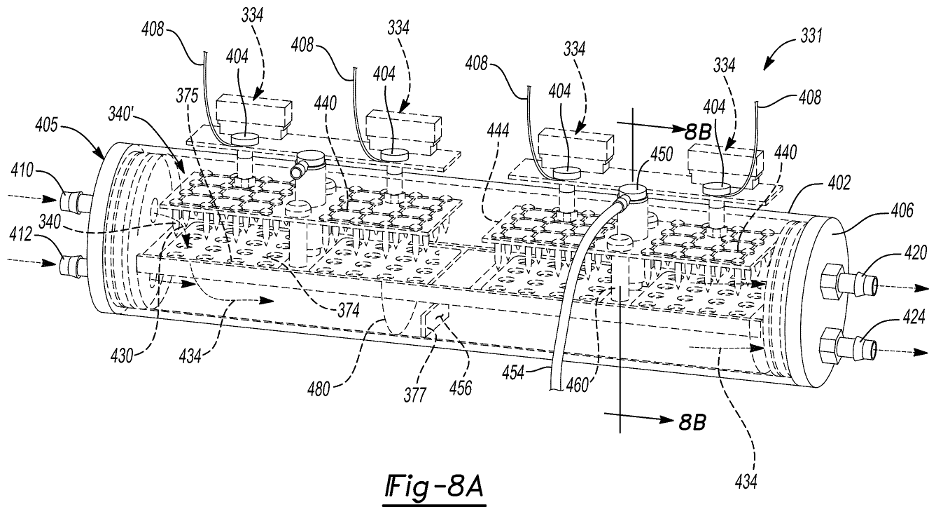

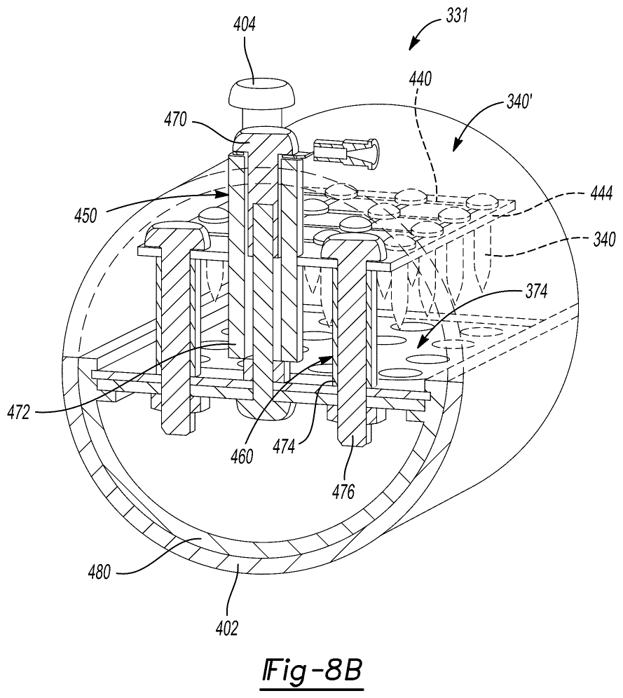

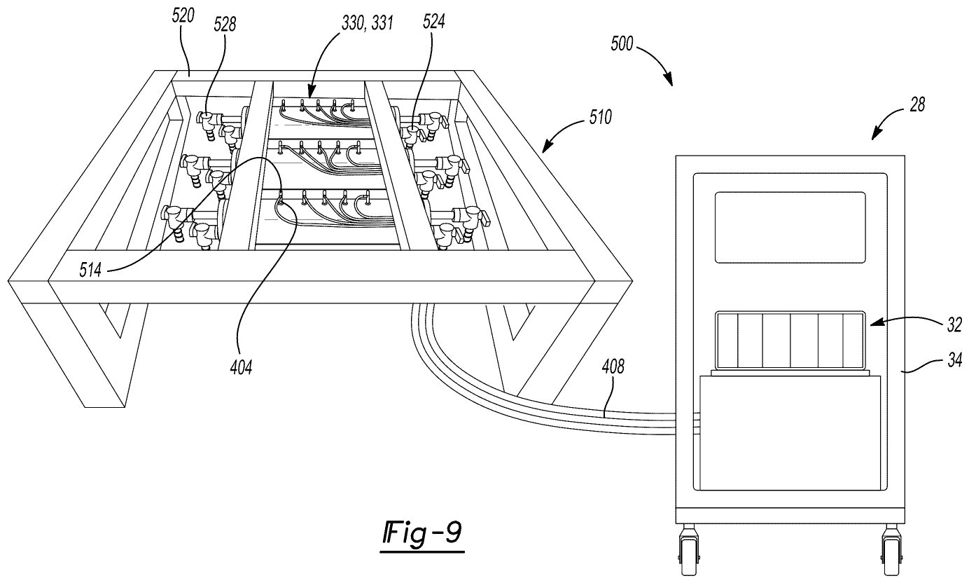

As discussed above, the PAG may be generated with a gas activation system. The gas activation generator 28 may have various components such as the generation portion 32 housed within the housing 24. The generation portion 32 may be controlled by various control components and mechanisms, as discussed above. According to various embodiments, an electrical current may be provided to a generator portion or tube, such as the generators 200 as discussed above. The electrical supply may be provided as a current or a voltage generated between two portions, as also discussed above. Accordingly, the electrical connectors 252 may allow for connection of a selected control board directly with the connections 256 with the generation members 242 having the points 240. In various environments, the electrical connectors 252 may also just include or be provided only as an electrical connection, such as a cable or appropriate conductor as illustrated in FIGS. 8A, 8B, and 9 as discussed further herein.

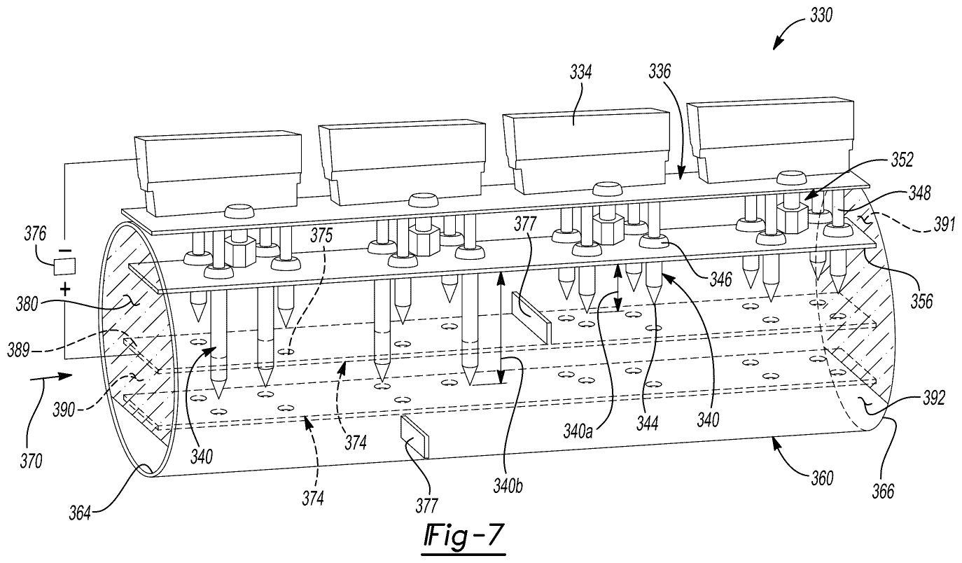

In various embodiments, such as with reference to FIG. 7, a generator 330 is illustrated. The generator 330 may be similar to the generator 200, 200′ discussed above. Various components of the generator 330 may be identical or substantially identical to the generators 200, 200′ noted above. Therefore, the details thereof will not be discussed in detail here and only a brief discussion may be provided. According to various embodiments, therefore, an electrical connector 334 may be provided to connect to a selected circuit board or distributor system 336 to distribute power or generate a voltage at selected components. The electrical connector 334 may also be provided to selectively control, such as a value of a voltage, a value of a current, a pulse timing or length of a voltage generation or current generation or delivery, or the like. Accordingly, the generator 330 may be operated in any appropriate manner, such as that discussed above or herein.

The electrical connector 334 may provide power and/or control to various components, such as the generator pins or members 340. The generator members 340 may include a selected construction, such as having a point or tip 344. The point or tip 344 may have a selected diameter, such as about 0.01 millimeters (mm). The tip 344 may be formed as a taper of the generator member 340 from a proximal or first end 346 of the generator member 340 to the distal point 344. The proximal end 346 may be connected to the distributor 336 such as with a connection 348. The various components may be insulated or uninsulated depending upon the attributes desired. For example, the connector 348 may be insulated to allow for an insulated environment to conductor therein prior to or for delivery of a current or generation of a voltage at the generator member 340.

A single or many connectors or fastener members 352 may be provided to interconnect the distributor portion 336 and a support plate or member 356. The support plate or member 356 may support the generator members 340 in a selected position within the generated 330.

According to various embodiments, the generator 330 may include the generator members 340 within a housing or casing 360. The casing 360 may be provided in an appropriate geometry and volume. The housing may contain for a selected time and/or allow a flow of a liquid, such as water, through the housing 360. Generally, the liquid may flow in a selected direction such as in an inlet 364 and out an outlet 366, generally in the direction of arrow 370. The fluid may, therefore, flow through the housing 360 at a selected rate. This allows for a selected volume of liquid to be selectively positioned near or in contact with the generator member 340 for a selected period of time. The dwell or flow rate may be selected to allow positioning the liquid at or near the corona for a selected period, such as 0.01 seconds to about 5 seconds or any appropriate time, including increments therebetween. The liquid may pass through the housing 316 in an appropriate manner, such as being pressured or pumped through the housing 360. The flow rate may be selected, as noted above, to assist in ensuring an appropriate dwell time or activation time with the generator members 340 and/or the points 344.

The generator assembly 330 may, according to various embodiments, include an optional electrode member 374. The electrode member 374 may assist in generating a field between the electrical connectors 334 and/or the distributor portion 336 and the electrode 374 such as by an electrical connection 376. The field may allow or assist in ensuring a distribution of a charge (e.g., flow or movement of electrons from the corona) within an internal volume 380 of the housing 360. The volume 380, however, need not include the electrode 374.

In various embodiments, the generator 330 may include a plurality of the electrodes or plates 374. The multiple electrodes 374 may be placed to assist in directing or generating the corona. In various embodiments, only one of the plates 374 may be provided, such as spaced away from all of the points 344. Thus, a liquid may flow or be positioned in the housing 360 and be near or in contact with the plate 374, but not any of the points 344. A corona generated at the points 344 may, however, still allow for interaction of electrons with the liquid to generate the selected species.

The generator 330 may generate the plasma activated liquid (PAL) by directly interacting with the liquid. For example, water may be passed through the housing 360. A voltage or current may be provided to the generators 340. As discussed above, a plasma (e.g., a cold plasma) in a corona may be generated at the tips 344 or selected portions of the generators 340. A selected portion may be submerged or adjacent to the liquid within the housing 360 to directly interact with the liquid to generate the selected species. For example, electrons from the plasma may interact with the liquid. The corona may be at least partly submerged in the liquid.

In various embodiments, the generators 340 may have a selected length, such as a first length 340a to extend a first distance from the support plate 356 into the volume 380. Various of the generators 340 may have a second length 340b to extend a second length into the volume 380. It is understood that various other of the generators 340 may include other or alternative lengths. Thus, an array of lengths of the generator members 340 may be provided into the volume of 380. The above configuration allows the liquid passing through the volume 380 of the housing 360 may be provided in a substantially laminar flow while still ensuring that a majority of the liquid volume comes in contact with a corona from one or more of the generators 340 or is near to one of the generators 340.

The generators 340 may act similar to the generators as discussed above. An appropriate voltage may be provided to the generators 340 to cause a corona to be formed at a selected portion of the generators 340, such as at the tip 344. The corona may cause the generation of a selected activated species, also similar identical to those discussed above. For example, if water is provided as the liquid flowing through the housing 360 the water molecules may interact with the plasma, or at least free electrons generated thereby, to generate the various active species such as hydroxyl groups, hydrogen peroxide, hydrogen gas, oxygen gas, or other selected active species, such as atomic species or chemical species.

As the portion of the liquid is activated as it passes the generators 340, the activated species is maintained and entrained or dissolved within the liquid passing through the housing 360. Therefore, the PAL may be generated without mixing with a PAG. This allows the PAL to be generated substantially directly without requiring a mixing of the liquid with the PAG. The selected chemical species may reside within the liquid, therefore, directly due to activation of the generator members and may include a selected mixture and concentration thereof without requiring a secondary mixing system.

According to various embodiments, the generator 330 may be provided to allow for a contact of the point 344 with the liquid such as at selected voltages. In various embodiments, only a corona or free electrons generated in a plasma at the point 344 may directly contact the liquid. Regardless, at least a portion of the generators 340, or at least a portion thereof, may be substantially directly contacting or very close in space to the point 344 to the liquid positioned at or flowing past the point 344.

Within the housing 360 may be the member 374 which may be an electrode (e.g., ground) and/or only a structure within the housing that is not directly electrically connected. The member 374 may be a turbulence member 374 that is placed to interact with a flow of the liquid. The member 374 may be provided to form turbulence, direct a flow of a liquid, or other appropriate purposes. For example, the plate 374 may have one or more passages 375 that allow or cause flow of a liquid from one side to the other. Further, one or more turbulence forming structures 377 may also be provided, either formed with the plate 374 or positioned otherwise within the housing 360. In various embodiments, the turbulence forming structures may extend from or be positioned relative to housing 360. The turbulence forming structures 377 may form turbulence within the housing 360 to assist in or ensuring a maximum contact between a corona generated at the point 344 at the generated 340 with a liquid passing through the housing 360. In various embodiments, one or more of the turbulence forming structures 377 may be provided at any appropriate position in any generator, such as the generators 200, 200′, and 200″ illustrated in FIGS. 6A, 6B, and 6C. The turbulence forming structures 377 may provide for forming turbulence in any of the generator by interacting with a fluid flowing therethrough, including a liquid or a gas. The turbulence forming structures 377 may be formed as single walls, portions with passages, multiple small members, etc.

Therefore, the flow through the housing 360 may be turbulent or laminar according to various embodiments. The array positioning, including plurality of lengths, of the generators 340 may assist with ensuring an appropriate contact to during a laminar flow. The turbulent structures, such as the holes 375 or the turbulence structure 377 (which may be provided as one or more members 377), may assist in forming a turbulent flow if an array positioning of the generators 340 is not provided. However, combinations of the above may also be used to assist in ensuring an appropriate contact and/or dwell time of the liquid with the corona. Further, as with generators in various embodiments, the generator 330 may include a limited end opening, according to various embodiments. For example, the end of the housing 360 may be closed, such as with one or more walls 389, 391, except for an opening or passage 390 and 392 to limit or direct a flow of a material, such as generally in the direction of arrow 370, through the housing 360. The flow of any material, such as a liquid (e.g., water) may be free through the housing 360, have turbulence induced such as with the members 377, and/or directed internally and/or with the walls 389,391 and passages 390, 392. These portions may be provided individually or in selected combinations and numbers to achieve a selected movement of the material to assist in achieving a selected contact of the material with the coronas to assist in making the selected species, as noted above.

According to various embodiments, a generator 331 may be provided. The generator 331 may be similar to the generator 200 and/or the generator 330 as discussed above. The generator 331 may be designed, according to various embodiments, to generate PAL and/or PAG. The generator 331, however may include the generators 340 (e.g., the pins or extension members) in a selected number such as an array of 16 generator members 340′ associated with each of the connectors 334, as illustrated in FIG. 8A.

The array 340′ may be associated with each of the connectors such as the connector 334 provides the power connection to each of the generators 340. Additionally or alternatively, a connector 404 may connect to one of more of the generator members, such as an array of 16 generator members 340′. Further, each of the generators 340 in the array 340′ may be positioned a distance from one another, such as about 1 millimeter to about 1 centimeter, or any appropriate distance. The array 340′, however may include more generators 340 than included in other examples or embodiments as illustrated above. One skilled in the art, however, will understand that any appropriate number may be provided in a selected array, such as nine, 25, or any appropriate integer. Further, the shape of the array may be selected in any appropriate manner such as based on spacing of the generators, space within a housing 402, number of generators, etc. The array may be in a regular or irregular geometric shape or any appropriate shape.

Further, the generator 331 may include the housing 402 that may or does house the components, such as the generators 340′. The generator 331 may also include other components such as the optional electrode member 374. The optional electrode member 374 may also include the bores or passages 375. The passages 375 may be provided in a number that is equivalent or equal to the number of the generators 340′. The passages 375 may also be provided to align with the generators or be offset therefrom.

The connectors 334 may not be used and the connectors 404 may alone be used. A conductor, also referred to as a cable 408 may be connected to the connector 404. The cable may carry a selected voltage and/or current to the connector 404. For example, about 5,000 volts to about 20,000 volts, including about 8,000 volts to about 12, 000 volts, and further including about 10,000 volts may be provide to the connector 404. Any appropriate potential may be provided that may be used to generate the coronas and the selected species, as discussed above. The potential provided may be between the generators 340′ and the plate 374 which may be ground plate or plane.

The housing 402 may be terminated with one or more end members or portions 405 and 406. The two terminal end portions may be separate and assembled together members 405 and 406. Alternatively, the end portions 405 and 406 may be formed integrally with the housing 402. The two ends 405 and 406 may include one or more passages, such as the end 405 including the passages 410 and 412 and the end 406 including the passages 420 and 424.

The passages 410, 412, 420, 424 allow entry and exit of fluids, such as gasses and liquids. The passages 410, 412, 420, 424 may separated by a distance to act as a mechanism for separating regions within the housing 402, such as the occluded or open regions as discussed above. The passages 410, 412, 420, 424 may have ports or connections for efficiency and able to be sealed connections to conduits that may be fluid tight, such as gas or liquid. Thus, fluid flow through the generator 331 may be selectively directed.

The number of generators 340′, such as having 16 rather than 4 generators in an array or regions may allow for a higher concentration of selected radicals, such as oxygen (ozone). For example, ozone generation with 16 generators in a region or the array 340′ may generate about 600 parts per million (ppm) of ozone, including about 200 ppm to in excess of about 1000 ppm ozone, as opposed to about 5 ppm with four generators 340 per array or region.

The generator 331 may be used for the generation of plasma activated gas or plasma activated liquid. According to various embodiments, for example, a gas may flow into the inlet 410 and through the generator 331, such as in the direction of arrows 430. Therefore the gas may flow through the plate 374 and out any or both of the outlets 420 and 424. In various embodiments the liquid may flow through the generator 331. To assist in maintaining a separation of the liquid from the various electronic components, such as the generator pins 340′, a liquid may flow through the inlet 412 and generally along the direction of arrow 434. The liquid may be held or positioned substantially stay away from the plate 374 and/or the generators 340′ as it flows through the generator 331 and out the outlet 424. Nevertheless, the generator 331 may be used to generate directly the plasma activated gas (PAG) and/or the plasma activated liquid (PAL) according to various embodiments. Thereafter, the PAG may be mixed with a liquid, such as water, as well.

Further the generator 331 may include a plurality of the arrays 340′, as illustrated in FIG. 8A. Each of the arrays 340′ may be connected to one of the connectors 404 and related cable 408. Thus, the potential may be applied to each of the arrays at the selected amount, as discussed above. The potential may be distributed amongst each of the arrays of generators 340 by traces, such as a trace 440 on a holding board or member 444. The trace 440 may allow for the distribution of the voltage to each of the pins 340.

The plate 374 may be connected to a ground via a ground connector 450 that may be connected to a ground cable 454. The ground connection may be provided at any appropriate position and the configuration in FIG. 8A is merely exemplary. For example, the ground may extend to be connected from below or away from the pin support 444.

The potential may be provided between each of the pins 340 and the ground plate 374. As discussed above this may assist in directing the flow or generation of electrons away from the pin and toward the plate 374 and/or a region 456 within the generator 331.

The pin support 444 and the plate 374 may be separated by a separator 460. The separator 460 may be insulated or an insulator such that the current does not flow between the support 444 and the plate 374. Thus, the power provided to the pins 340 through the connector for 404 and the trace 440 may not travel through the support 460 to the plate 374.

Each of the connections may be substantially rigid. For example, the connector 440 may be a substantially rigid conductive member that connects between the housing 402 and the support 440. The support 460 or spacer 460 may also be a rigid member that interconnects the support 440 and 374. Thus, there is or may be a substantially rigid and inelastic connection between the support 444 and the housing 402 and the support 444 in the plate 374.

With continuing reference and to FIG. 8A and additional reference to FIG. 8B, the generator 331 may include the connector 404 that may be connected to the array 340′. The connector members may be metal or metal allow pins or bolts. The traces 440 may carry the power from the connector 404 to reach of the respective pins 340. The ground connector 450 maybe provided is a conductive member and/or a plurality of members 470 and an insulated member 472. Thus, a current may not be provided to the plate 444 through the ground connector 450. Additionally, the supports 460 may include an external insulating portion 474 and any appropriate internal portion, such as a bolter screw 476.

Additionally the generator 331 me include a support member or portion 480 the support portion 480 may support or hold the generating assembly within the generator 330 such as by engaging or holding the discharge plate 374. Further the holding member or assembly 480 may include one or more disrupting or turbulence generating portion, such as the dam 377 as discussed above. The supporting 480 may assist in supporting the generating portion within the generator 331 and/or providing for turbulence such as to mix a liquid within the generator 331.

With reference to FIG. 9, according to various embodiments, a generator system 500 may include various portions, such as the voltage generator system 28 and housing 34, that includes various components such as the electronic components 32. The electronic components 32 may provide a selected current or voltage through one or more cables 408 that may be connected with one or more of the connectors 334 and/or 404.

The cable 408 may connect with a plurality of the connectors 404 in one or more of the plasma generators 330, 331. For example an array of the plasma generators 330, 331 may be provided in an assembly 510. Each of the plasma generators 330, 331, for example three of the generators 330, 331, may be provided in an array. It is understood, however, that any appropriate number of the plasma generators may be provided and that three is merely exemplary. Further, the plasma generators 330, 331 may be provided in an appropriate length or selected dimension and the illustrated dimension is not necessarily to scale. Nevertheless, the cable 408 may include a more than one lead that have lead connections 514 that connect to the various electrical connectors 334, 404.

The voltage generator system 500 may include the plasma generators 330, 331 connected by the cable 408 to the electronics 32. One or more of the plasma generators 330, 331 may be held within a holding structure 520 formed in any appropriate manner, such as open or enclosed. The plasma generators 330, 331 may be provided to interact with a static volume of liquid or with a flow of liquid, according to various embodiments. Nevertheless, each of the plasma generators may have one or more valves, such as a first valve 524 and a second valve 528. The valves 524, 528 may respectively or selectively be inlet or outlet valves. It is understood that the generator 330, 331 may include a plurality of valves and the two valves is merely exemplary.

Thus, the voltage generator system 500 may include the electronics 32, as discussed above, to provide a voltage or current to the plasma generator 330, 331 as discussed above. The plasma generator 330, 331 may allow for an interaction of a corona with a liquid to allow for generation of selective species substantially directly within the liquid, as discussed above.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques). In addition, while certain aspects of this disclosure are described as being performed by a single module or unit for purposes of clarity, it should be understood that the techniques of this disclosure may be performed by a combination of units or modules associated with, for example, a medical device.

In one or more examples, the described techniques may be implemented in hardware, software, firmware, or any combination thereof. If implemented in software, the functions may be stored as one or more instructions or code on a computer-readable medium and executed by a hardware-based processing unit. Computer-readable media may include non-transitory computer-readable media, which corresponds to a tangible medium such as data storage media (e.g., RAM, ROM, EEPROM, flash memory, or any other medium that can be used to store desired program code in the form of instructions or data structures and that can be accessed by a computer).

Instructions may be executed by one or more processors or processor modules, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor” as used herein may refer to any of the foregoing structure or any other physical structure suitable for implementation of the described techniques. Also, the techniques could be fully implemented in one or more circuits or logic elements.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed:

1. A plasma activated material generation system, comprising:
a housing having a fluid inlet and a fluid outlet; and
a corona generating point;
wherein the corona generating point is operable to create selected species within the fluid by generating a corona at the corona generating point.

2. The system of claim 1, wherein a corona generation point includes a plurality of corona generating points.

3. The system of claim 2, further comprising:
a plurality of generating members wherein each generating member of the plurality of generating members has one generating point of the plurality of corona generating points.

4. The system of claim 3, wherein the plurality of corona generating points are positioned in an array within the housing.

5. The system of claim 4, wherein the array is configured to maximize contact of a liquid with the plurality of corona generating points.

6. The system of claim 4, wherein the array is formed by at least one generating member having a length different than another generating member.

7. The system of claim 3, further comprising:
an electrical control system configured to control generation of a corona at the corona generating points.

8. The system of claim 7, further comprising:
a voltage generator configured to generate a charge at the corona generating points via the electrical control system.

9. The system of claim 1, further comprising:
an inlet fluid manifold coupled to the fluid inlet; and
an outlet fluid manifold coupled to the fluid outlet;
wherein the fluid conduit includes a plurality of fluid conduits;
wherein each of the fluid conduits extend and allow for fluid flow between the inlet fluid manifold and the outlet fluid manifold.

10. The system of claim 1, further comprising:
a liquid flow regulator;
wherein the liquid flow regulator regulates a flow of the liquid at least from or to the housing.

11. A method of generating a plasma activated material, comprising:
providing a liquid to a housing having a fluid inlet and a fluid outlet; and
providing a corona generating point within the housing; and
generating a corona at the corona generating point operable to create selected species within the liquid.

12. The method of claim 11, further comprising:
flowing the liquid through the housing from the fluid inlet to the fluid outlet;
wherein the selected species is created directly within the liquid.

13. The method of claim 11, further comprising:
providing a plurality of the corona generating points.

14. The method of claim 13, further comprising:
providing a plurality of generating members; and
providing each generating member of the plurality of generating members to include one generating point of the plurality of corona generating points.

15. The method of claim 14, further comprising:
providing the plurality of corona generating points in an array within the housing.

16. The method of claim 15, further comprising:
maximizing interaction of a liquid with the plurality of corona generating points.

17. The method of claim 14, further comprising:
controlling generation of a corona at the corona generating points with an electrical control system.

18. The method of claim 14, further comprising:
operating a voltage generator to generate a charge at the corona generating points via the electrical control system.

19. The method of claim 11, further comprising:
providing a fluid inlet manifold coupled to the fluid inlet; and
controlling at least one of a pressure or a flow rate of the liquid to the housing via the fluid inlet manifold.

20. The method of claim 11, further comprising:
regulating a liquid flow at least into or through the housing.

21. A plasma activated gas (PAG) generating system operable to generate PAG, comprising:
a casing extending from a first end to a second end;
a plate separating a first portion from a second portion between the first end and the second end; and
at least one corona generating member positioned a distance from the plate;
wherein the corona generating member is configured to generate a corona to generate selected species within a fluid;
wherein the plate defines passages configured to direct the fluid within the corona.

22. The system of claim 21, wherein the corona directly affects the fluid.

23. The system of claim 22, wherein the fluid is a gas.

24. The system of claim 23, further comprising:
a mixing system comprising:
a fluid conduit having a liquid inlet;
an infusing member in the fluid conduit; and
a gas conduit to the infusing member from the casing;
wherein a liquid is operable to enter the liquid inlet and be infused with the PAG at the infusing member;
wherein the fluid is infused with the PAG to optimize a radical concentration in the fluid given a number of corona generator and fluid flow rate.
